(19) United States
(12) Patent Application Publication
(10) Pub. No.: US 2007/0276824 A1
(43) Pub. Date: Nov. 29, 2007

(54) Control System for the Retrieving Html Data

(76) Inventor: Anwar Bashir, Stockton-on-Tees (GB)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/560,866

(22) PCT Filed: Jun. 14, 2004
(86) PCT No.: PCT/GB04/02555

§ 371 Date: Feb. 2, 2007

(30) Foreign Application Priority Data
Jun. 14, 2003 (GB) 0313800.5
Apr. 19, 2004 (GB) 0408591.6

(51) Int. Cl. G06F 17/30

(52) U.S. Cl. 707/6; 707/E17.061

(57) ABSTRACT

A control system for controlling a physical device includes a computer, a controlled device, and a micro-controller having input means and output means, the controller including micro-controller software, wherein the micro-controller software is programmed to generate a hypertext transfer protocol request (http) upon receipt of an input signal by the micro-controller input means, which request is transmitted to the computer via the output means, wherein the transmission of data from the device to the computer is performed by the micro-controller, and wherein the micro-controlled software is programmed to receive text data contained in a web page, the said data including control information, and upon receipt of such data the micro-controller software identifies the control information contained in the web page, and allows a control signal to be sent from the computer to the controlled device.

This invention relates to a communications system for controlling access to control equipment and facilities and providing management information on the use of those facilities using the commonly used HyperText Mark-up Language (HTML) and other human readable text based languages used in web pages in a novel way.

A typical control system in a modern office environment consists of a variety of independent hardware and software elements often linked to management information systems by bespoke means.

A medium sized business environment will contain photocopiers, printers, door access control, car parking control, fire alarm system, and temperature control system. These communicate by means of various communication links such as Local Area Networks (LAN), Analogue Cabling, Serial Lines, Fieldbuses, or even Satellite Communications. This mix of devices and communications will be supported by discrete programming methods that are not the same across the entire enterprise. This is not only inconvenient for both staff and management but it is also expensive and inefficient.

The problem has been recognised by others and efforts are being made to address the issues by adopting common communication standards.

A specification known as CORBA (Common Open Request Broker Architecture) has been developed. This suggests a simple approach but in fact it requires sophisticated programming to achieve the desired result of a common system for users of office equipment and facilities.

Another system known as COBA (Connected Open Building Automation) is a standardization effort initiated by a consortium of 15 companies in the construction, building, automation, telecommunications and information technology industries. This suggests an open standard for easy and secure access to buildings but to date it has not led to manufacturers sharing a single universal standard.

Neither approach has resulted in a simple universal programming language that offers standard connectivity for all common office equipment and services.

Generally the control system industry continues to develop products for specific markets (e.g. home, buildings, office equipment etc.) and each market sector develops relatively complex systems that are difficult to adapt across market boundaries. A technology that is simple to use and enables seamless cross-market development would dearly reduce business costs and create new market structures.

Access to on screen information across computer networks has largely been standardised by the almost universal adoption of HTML (HyperText Markup language). However, the actual control of physical devices has not been accomplished by a similar universal programming standard. The methods currently used are often peculiar to one particular type of physical device; for instance, the program that controls a security door would be different from that used to allow usage of a photocopier.

It could be argued that the growth of the World Wide Web on the Internet could be traced back to the invention of HTML. HTML suffers from a lack of one feature that is important to programmers; it is stateless (i.e. information is not retained). In order to retain information HTML programmers have developed additional tools such as, CGI (Common Gateway Interface) scripts, ASP (Active Server Pages), JSP (Java Server Pages) and PHP (Hypertext Preprocessor). These server side technologies allow designers to create applications that are dynamically generated. Often database-driven, these advanced sites can be updated and maintained more readily than static HTML pages.

The transport and delivery mechanisms that led to the rapid expansion of the Internet require only minimal adaptation to become applicable to control systems. Technologies already exist that could be utilised to provide control systems that are far easier to develop and maintain than the bespoke solutions currently available. The precise nature and mixture of products is a matter of choice. There is a plethora of products that can establish such an environment; a common open source system is a Linux server, running an Apache web-server, a MySQL database and a PHP service. This configuration is becoming known under the generic term of LAMP (Linux, Apache, MySQL and PHP). The provision for additional technologies to format and extend functionality such as Extended Markup Language (XML) and the Simple Object Management Protocol (SOAP), promoted in some texts, creates complexity that is counter productive to the aim of providing a simple standard that could be used by casual programmers.

According to the present invention there is provided a control system for physical devices as specified in Claim 1.

According to another aspect of the invention there is provided a micro-controller as specified in Claim 26.

According to another aspect of the invention there is provided a computer program as specified in Claim 27.

According to another aspect of the invention there is provided a method for controlling physical devices as specified in Claim 28.

Human readable text languages used in web pages, such as HTML are not only well known but also easy to learn and very simple to use. Their exploitation does not require specialists in information technology with a high level of knowledge and experience.

In the invention text source code is returned from a computer in a web page in response to a hypertext transfer protocol (http) request. The source code contains data designated for control purposes. This is either encapsulated within a structure or filtered from other data within the returned source code. The structure could be a table, with fields containing data relating to a control instruction or simply data delimited by a comma or some other character.

The invention eliminates the need to use bespoke programming systems across a computer network. In the invention the control data is returned as human readable text in a web page.

In the invention it is possible to locate and act upon control information using a common approach.

The invention will allow new office equipment to have a standard communications technology to be built-in.

The invention can be used with existing hardware; it is not necessary to re-equip an office with new equipment.

The invention will allow control systems to be driven from data normally presented on-screen. The relevant information is presented with some structure in order that a microcontroller program can easily identify and process control instructions.

The invention will allow Graphical Objects to be presented on-screen as a web-page allowing further simplification and control. For instance, a web-page displaying an icon of a closed door when clicked will open a door and the image will change to an open door icon, or vice versa.

The invention will allow a single technology to be shared, developed and used for control application across vendor boundaries.

The invention will allow on-screen application error checking for development prior to commitment to micro-controller programs.

The invention will provide the communications infrastructure for a solid-state multifunctional control device. The need for a hard-drive or complicated operating system is eliminated. A simple micro-controller that can send an http request and receive the response will suffice.

The invention can also be made available for training purposes. Knowledge about control systems could be disseminated in an intuitive way leading to greater understanding and development, similar to the way in which HTML for web programming developed. For example, an electronic training board with lights switches and displays can be connected to a home network. A home computer can then be used to communicate using the control system of the invention to control the board and observe the changes both on the board and the home computer using an Internet browser. In time this would help to de-mystify control technology. It might also lead to a new generation of users that understand that device control can be simple. In time this could promote better understanding of control technologies and lead new opportunities in a variety of market sectors.

The invention can be recognised by any micro-controller that is capable of supporting network (UTP) port, with Transmission Control Protocol/Internet protocol (TCP/IP) connectivity.

The invention can be used by the micro-controller for initialisation and configuration, thus enabling a general micro-controller to determine its operation from an Internet server.

The invention allows control systems to be driven from information held in tables from applications such as spreadsheets.

The invention provides the basis for the development of a ubiquitous ‘blackbox’ network communication device that simply plugs into a device on one side and the Internet on the other and instantly enables information exchange between the two.

The invention provides the ability of ‘network enabling’ almost any device.

The invention does not concern itself with the applications that are used to generate the human readable text in web pages; hence it provides an open platform for practitioners to develop using whatever means they prefer. The only recommendation would be to structure the data.

The invention provides a structured adaptation of human readable text data in web pages that could enable practitioners of control technology to teach a single methodology for device control.

The invention enables companies to establish a cashless infrastructure.

A specific example of the invention will now be described by way of example with reference to the accompanying drawings in which:

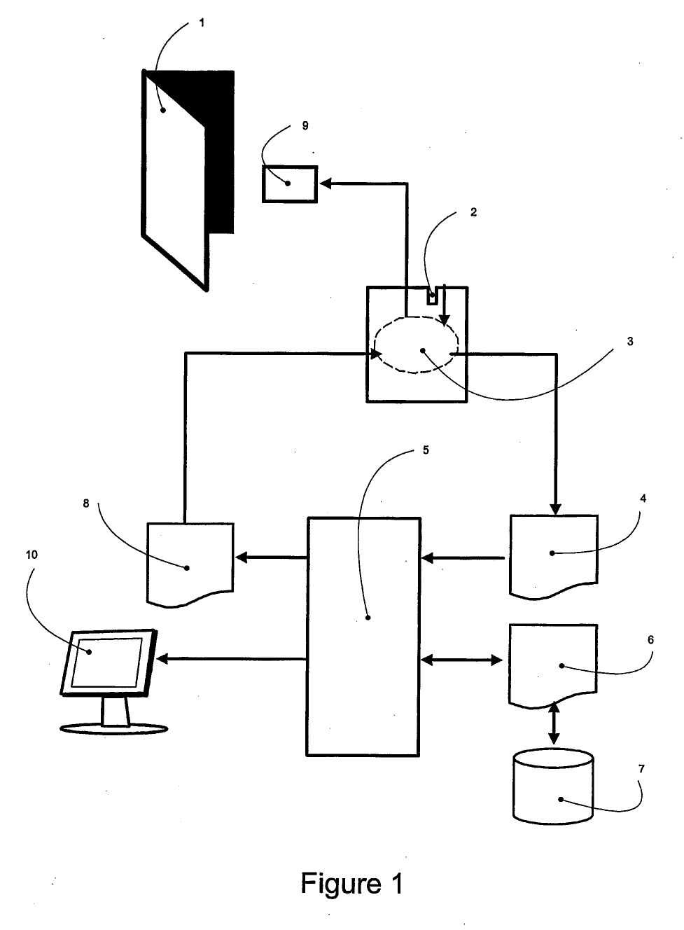

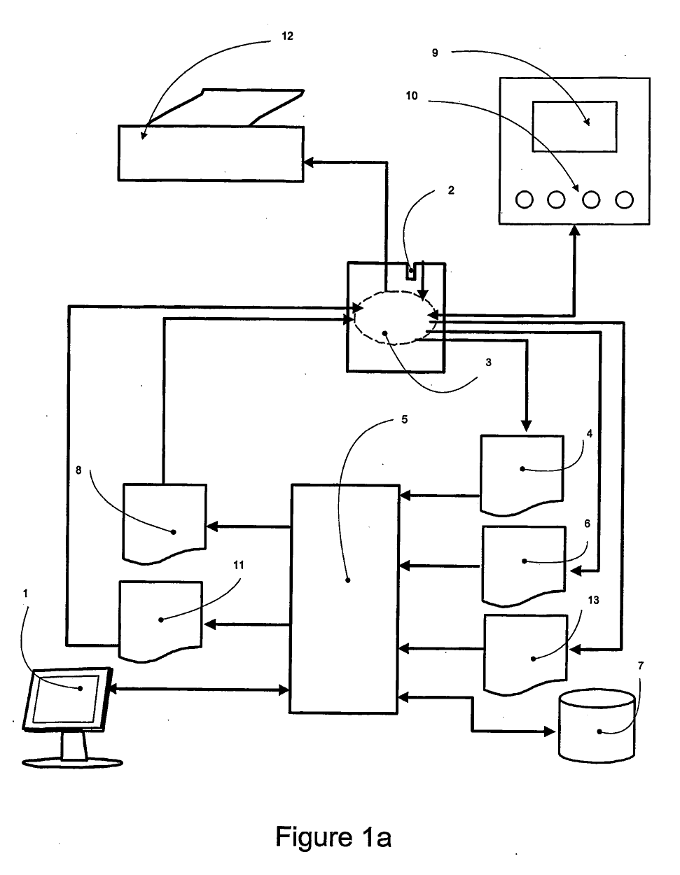

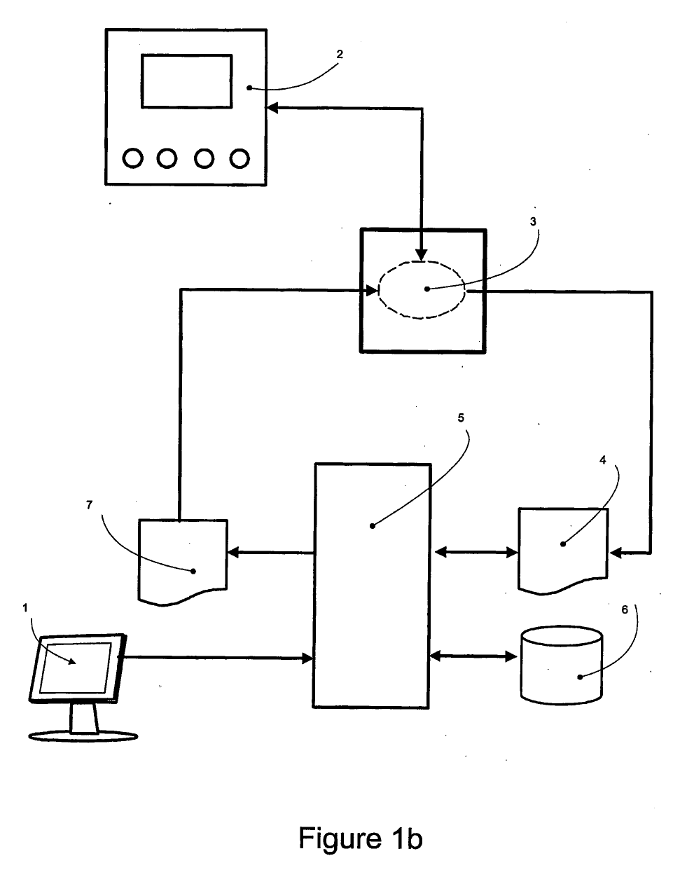

FIG. 1 shows a typical office environment and how it can be controlled and monitored;

FIG. 1a is a schematic representation of a control system of the invention where the controlled device is a printer;

FIG. 1b is a schematic representation of a control system of the invention where the controlled device is a machine tool;

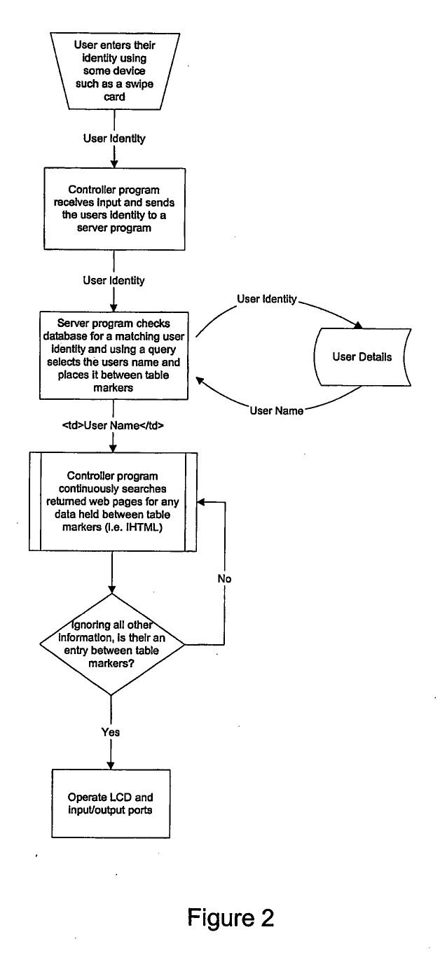

FIG. 2 is a flow diagram illustrating the operation of the system in general terms using the example of an authorised person gaining access to a security door; and

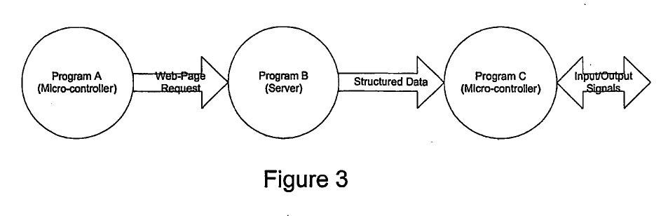

FIG. 3 is a diagram illustrating the programs that interoperate in order to establish communications between the micro-controller, the device connected to the micro-controller and a networked computer (server).

In FIG. 1 it can be seen that when a person requires entry through a security access door 1 for example he identifies himself by inserting an identity card into a swipe card reader 2. The swipe card reader 2 interfaces with a micro-controller program 3. The micro-controller program 3 receives card data. The user identity that is contained within the card data is sent by means of a network request 4 to the server 5. A server program 6 inspects the database 7 for matching information. If the user identity is valid the person's actual name is returned with table data markers 8 to the micro-controller program 3 via the server 5.

The door 1 could be any control requirement and examples in an office environment might include a photocopier, a car park barrier, fire alarm system, temperature control system, printer etc. The lock 9, which controls access via door 1, might be any form of actuator like a solenoid or micro-switch for example.

The client management information system 10 permits a manager to communicate with the database 7 via a reporting application (not shown).

In the prior art the micro-controller program 3 is vendor specific but in the present invention it replaced by a standard program that looks for patterns in data and strips out relevant information. This type of program is often referred to as a parser. This parser inspects HTML code and selects relevant information depending on nature and context. This information facilitates some control requirement. This method is simple and uses open standards.

In the prior art a network request code 4 is vendor specific but in the present example it is replaced by an Internet request, i.e. http://www.some-site.com. This replaces the plethora of complex network request methodologies currently available.

In the prior art the server 5 uses software that is vendor specific but in the present example is replaced by an open database driven server architecture. This enables servers to be configured and used for control requirements by a far larger community of people.

In the prior art the database 7 would use software that is vendor specific but in the present invention the database 7 can be non-vendor specific using simple, affordable databases and providing users with greater flexibility and choice.

Referring now to FIG. 1a, a person (not shown) at the terminal 1 submits print jobs to the computer 5. The print jobs are stored in the computer 5 together with the person's identity. When the person requires the print job he identifies himself by inserting media carrying identity information into the swipe reader 2. The swipe card reader 2 interfaces with a micro-controller program 3. The micro-controller program 3 receives card data. The user identity that is contained within the card data 4 is transmitted to the computer 5. A computer program matches the stored print jobs with the user's identity and locates any matches. Matching print job data 8 is transmitted to the micro-controller program 3. The pint jobs are displayed to the person as a selection list on an LCD display 9. The person selects print jobs using the buttons 10. The micro-controller program 3 transmits job release selection information 6 to the computer 5. The person's credit status may also be checked via the database 7 before proceeding. The computer 5 releases the selected print job 11 to the printer 12 via the micro-controller program 3. After the print job has printed the micro-controller program transmits completion data 13 to the computer. The computer records print job completion data in the database 7. The database 7 provides transaction logging.

Referring now to FIG. 1b, a person at the terminal 1 stores a human readable machine tool program file onto the computer 5. The machine controller 2 requests a machine tool program. The microcontroller program 3 receives the request. The micro-controller program 3 passes an http request for the file 4 to the computer 5. The computer 5 may also log the file request into the database 6. The computer 5 transmits the machine tool program 7, via http, to the micro-controller program 3. The micro-controller program 3 parses the control data and passes control data to the machine controller 2. The database 6 provides transaction logging.

The database is a repository of information

In the case of machine tools, in addition to a set of generic instructions suitable for instructing a type of machine tool controller to machine a work piece, it is necessary to add what is known as post processing information particular to the actual machine tool controller being used to the set of generic instructions in order for the work piece to be properly finished. The invention allows post processing information to be accessed easily, particularly if that information is held on a database.

The database may be not required in all circumstances. However, amongst its uses, it can provide the micro-controller program with dynamically changeable data. The micro-controller accesses this data by transmitting a hypertext transfer protocol (http) request. This request triggers a program on the computer that can access the data in a database. This is a well-understood and known practice. The request will by its nature return information in a form that assumes that the data is destined for a web-browser. In fact, a micro-controller program will receive the data. The micro-controller program must therefore ignore information designed for web-browser readability and instead find the control information relevant to the request. In order to simplify the micro-controller program it is recommended that the computer program returns structured control data. This may be accomplished by delimiting the data with commas or some other character, or even better in a table.

For simplicity, the database is described as a single entity, however in practice the sources and storing of information may be several and have differing types.

The micro-controller program does not always require data from a database. In the example of the machine tool controller the database is not a functional requirement. However, its ability to offer the facility provides a mechanism for providing information that would otherwise be generated by limited and bespoke means. The micro-controller equipped with a UTP port with TCP/IP connectivity is capable of supporting various communications standards. The ability to receive HTML data and parsing it is an addition designed to offer an alternative to bespoke communications control systems.

The computer is required to serve requests for information from micro-controller programs. The micro controller could control devices without requiring network connection. However, this would limit its function. In order to adapt to multiple requirements network connection is required. The fact that, in this application, the network connection is supported by Internet standards provides additional versatility.

FIG. 2 is a flow diagram that illustrates the operation of the system in general terms using the example of an authorised person gaining access to a security door. Many other devices could be controlled such as; photocopiers, printers, car-park barriers, vending machines, cash tills.

The control of such devices using a common communications standard obviously benefits companies by the advantages available from economies of scale. Moreover, it provides the ability to cross-market boundaries with the same connectivity available to manufacturing industries to control devices or provide quality control. For example common machine tool controllers such Heidenhain and Fanuc could be enhanced by HTML enabled micro-controllers.

FIG. 3 illustrates communication between three programs that demonstrate the basic requirements of the control protocol and its operation. Program A makes an http request; Program B serves the request perhaps by way of a database request; Program C locates control data and provides some control function.

With further reference to FIG. 3, a description and actual code for Program C is provided below which reveals how it locates user name information. In this case if a valid user identity were found the micro-controller might engage a solenoid. The program provides the basic knowledge required to develop an understanding of the Internet request and reply and indicates how the reply could be used to perform a control function.

The program assumes that the user name will be found between HTML table data markers. The program creates a variable ‘UserNAME’ into which the data can be stored. The program searches the web-page (HTML) until a table data marker is found. The data between this marker and the next end of table marker is then stored in the variable.

| Description | Program C running on micro-controller |
|---|---|
| Initialise variable to store user | UserNAME[0] = 0; |
| name. | |

while ((c <len) && (UserNAME[0] == 0))

Loop

{

if (c >4 &&

buffer[c] == ‘>’ && buffer[c−1] == ‘d’ &&
buffer[c−2] == ‘t’ && buffer[c−3] == ‘<’)

While not end of buffer data

{

(web page)

i=0;

Search each line for <td>

while (c <len − 5 && buffer[c+1] !=

marker in HTML page

‘<’ && buffer[c+2] != ‘/’

| | |
|---|---|
| If <td>found store data | && buffer[c+3] != ‘t’ && |

| | |
|---|---|
| between this and the next <td> | buffer[c+4] != ‘d’ |

| | |
|---|---|
| EndWhile | && buffer[c+5] !=‘>’) |

| | |
|---|---|
| Store data in variable. | { |

EndLoop

UserNAME[i] = buffer[c+1]; //read data

into UserNAME

Copy contents of buffer into

//printf(“c=%d b[c]=%c i=%d

UserNAME.

UserNAME[i]=%c\n”,c,buffer[c+1],i,UserNAME[i]);

i++;
c++;

}
UserNAME[i] = 0;
Success = 1;

Terminate UserNAME

}
c++;

}

The control data could be provided to Program C (micro-controller) without any strut. However if control data is formatted between table markers it makes it easier for the micro-controller program to locate relevant data.

This strategy enables separation of implementation from interfaces, for instance it is not necessary to know how to program a computer port directly or understand the protocols used. The interfaces (not shown) can be packaged in terms of objects and made known to the micro-controller program, i.e. expressing the request in a higher-level form of language (e.g. open port A, close port B—not shown).

This presents casual and dedicated developers alike with the relatively simple task of creating a web-page that appears to be automatically read by a micro-controller that is used to designate some control requirement like a security access door.

1. A control system for controlling a physical device including a computer, a controlled device, and a micro-controller having input means and output means, the controller including micro-controller software, wherein the micro-controller software is programmed to generate a hypertext transfer protocol request (http) upon receipt of an input signal by the micro-controller input means, which request is transmitted to the computer via the output means, wherein the transmission of data from the device to the computer is performed by the micro-controller, and wherein the micro-controlled software is programmed to receive text data contained in a web page, the said data including control information, and upon receipt of such data the micro-controller software identifies the control information contained in the web page, and allows a control signal to be sent from the computer to the controlled device.

2. A control system according to claim 1, wherein the text data contained in the web page is written in HyperText Markup Language (HTML).

3. A control system according to claim 1, wherein the text date contained in the web page is written in the American Standard Code for Information Interchange (ASCII).

4. A control system according to claim 1, wherein the controlled device receives a control signal via the micro-controller, the control signal causing the controlled device to perform an operation dependent on the nature of the information carried by the control signal.

5. A control system according to claim 1, wherein the computer receives the http requests generated by the micro-controller and generates an output signal contained within text data in a web page for transmission to the micro-controller, and wherein on receipt of the said output signal the micro-controller performs a control operation on the controlled device.

6. A control system according to claim 1, wherein the micro-controller includes a filter, the filter allowing passage of control information contained within the text data, and preventing passage of other data contained within the text data.

7. A control system according to claim 1, wherein the filter is a text parser.

8. A control system according to claim 7, wherein the text parser is an HTML parser.

9. A control system according to claim 1, further including a database.

10. A control system according to claim 9, wherein the system compares information associated with an http request from the micro-controller with information stored on the database, and wherein if the comparison meets a criteria the computer generates a control signal for controlling the device, and if the comparison does not meet a criteria the computer does not generate a control signal for controlling the device.

11. A control system according to claim 9, wherein events that occur in the system are recorded in the database.

12. A control system according to claim 11, wherein http requests generated by the micro-controller software are recorded in the database.

13. A control system according to claim 1, wherein the said micro-controller is part of the said computer.

14. A control system according to claim 1, wherein the controlled device is a machine tool.

15. A control system according to claim 14, further including a database, and wherein the machine tool sends a signal to the micro-controller via the input means requesting machining instructions, and wherein the micro-controller generates an http request requesting the machining instructions from the computer, and the computer interrogates the database for machining instructions for the said machine tool, and wherein if instructions for the said machine tool are located on the database, the said instructions are transmitted via the computer to the micro-controller with a control signal contained in a web page commanding the micro-controller to allow passage of the said instructions to the said machine tool.

16. A control system according to claim 14, wherein the machine tool sends a signal to the micro-controller via the input means identifying the said machine tool, and wherein the micro-controller generates an http request to the computer requesting processing information unique to the said machine tool, and wherein the said unique processing information is applied to instructions transmitted to the said machine tool.

17. A control system according to claim 1, wherein the controlled device is a printer, or a photocopier, or a fax machine, or an access barrier.

18. A control system according to claim 17, wherein the micro-controller input means is a swipe card reader, and wherein personally identified information related to the controlled device is stored on the computer, and when a swipe card is passed through the swipe card reader an http request including the personal identity of the card holder is sent to the computer, and wherein the said personally identified information held on the computer having a personal identity matching the personal identity transmitted in the http request is transmitted to the micro-controller, and wherein the micro-controller transmits information release data to the computer which transmits the information to the controlled device via the micro-controller.

19. A control system according to claim 18, wherein the system further comprises an inter-active display, and wherein information held on the computer having a personal identity matching the personal identity transmitted in the http request are displayed on the inter-active display.

20. A control system according to claim 19, wherein the information displayed on the inter-active display may be manually selected using the inter-active display.

21. A control system according to claim 19, wherein the personally identified information comprises print jobs, or photocopier jobs, or fax jobs, or access permissions.

22. A control system according to claim 1, wherein the data contained in the text of the web page transmitted to the computer in response to an http request is marked.

23. A control system according to claim 22, wherein marking data consists of tabulating said data, or placing said data between computer readable markers.

24. A control system according to claim 1, wherein the computer is a server.

25. A control system according to claim 24, wherein the server is an Internet server, or is a network server.

26. A micro-controller suitable for use in a control system according to claim 1.

27. A computer program comprising computer program instructions which, when loaded into the micro-controller constitute the micro-controller software of the control system of claim 1.

28. A method of controlling a physical device using a control system according to claim 1, comprising the following steps:
i) the micro-controller software generates an http request upon receipt of an input signal by the micro-controller input means;
ii) transmitting data from the device to the computer via the micro-controller;
iii) the micro-controller software receives a web page containing text data and identifies control information contained in the text data; and
iv) enabling a control signal to be sent from the computer to the controlled device.

29. (canceled)
